(19) United States
(12) Patent Application Publication
(10) Pub. No.: US 2007/0205534 A1
(43) Pub. Date: Sep. 6, 2007

(54) Method for manufacturing a vane of ceiling fan

(76) Inventor: Wen-Tsung Ko, Shengang Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/367,489

(22) Filed: Mar. 6, 2006

(51) Int. Cl. B29C 65/06

(52) U.S. Cl. 264/248; 156/73.5

(57) ABSTRACT

A method for manufacturing a vane of ceiling fan, including steps of: making an upper half and a lower half of the vane by means of injection molding, the upper half and lower half of the vane having symmetrical profiles and respectively having two recessed mating faces for mating with each other; respectively placing the upper half and lower half of the vane into the mold cavities of an upper mold section and a lower mold section of a vibrational friction device, whereby the mating faces of the upper half and lower half of the vane are mated with each other; and activating the vibrational friction device to vibrate at high-frequency, whereby the mating faces of the upper and lower halves of the vane melt due to thermal friction effect and integrally associate with each other to form a hollow vane of ceiling fan.

### BACKGROUND OF THE INVENTION

The present invention is related to a method for manufacturing a vane of ceiling fan. An upper half and a lower half of the vane are formed by means of injection molding. The upper half and lower half of the vane respectively have two recessed mating faces for mating with each other. By means of thermal friction effect, the mating faces of the upper and lower halves of the vane are molten and integrally associated with each other to form a hollow vane of ceiling fan.

The vanes of the existent ceiling fans are made of wooden or plastic materials. The plastic-made vanes of the ceiling fans have monotonous appearances. The wooden vanes of the ceiling fans are solid and made from light wooden materials and necessitate sculpture, grinding, polishing and painting. Therefore, the manufacturing procedure of the wooden vanes is quite troublesome and complicated. As a result, the manufacturing cost is relatively high.

In the case that the vanes are made of plastic materials with solid pattern, the weight of the vanes must be considered. In order to reduce the weight of the vanes, each vane can be composed of two halves which are respectively formed and then mated with and adhered to each other by means of glue. According to the above measure, it is difficult to accurately mate the two halves with each other. In addition, the glue often spills from the vane. This will affect the appearance of the vanes of the ceiling fan. Moreover, during rotation of the ceiling fan, the vanes are subject to vibration. It often takes place that the halves of the vane depart from each other due to poor adhesion effect.

### SUMMARY OF THE INVENTION

It is therefore a primary object of the present invention to provide a method for manufacturing a vane of ceiling fan. An upper half and a lower half of the vane are formed by means of plastic injection molding. By means of thermal friction effect, the mating faces of the upper and lower halves of the vane are molten and integrally associated with each other to form a hollow vane of ceiling fan. The vane can be designed with various patterns. In addition, the vane has lighter weight and is more durable.

According to the above object, the method for manufacturing the vane of the ceiling fan includes steps of:

making an upper half and a lower half of the vane by means of injection molding, the upper half-and lower half of the vane having symmetrical profiles and respectively having two recessed mating faces for mating with each other;

mating the upper half and lower half of the vane, the upper half and lower half of the vane being respectively placed into the mold cavities of an upper mold section and a lower mold section of a vibrational friction device, whereby the mating faces of the upper half and lower half of the vane are mated with each other; and

activating the vibrational friction device to vibrate at high-frequency, whereby the mating faces of the upper and lower halves of the vane melt due to thermal friction effect and integrally associate with each other to form a hollow vane.

The present invention can be best understood through the following description and accompanying drawings wherein:

### BRIEF DESCRIPTION OF THE DRAWINGS

FIG. 1 is a perspective exploded view of the vane of the present invention, showing the upper mold section and lower mold section of a mold, in which the upper half and lower half of the vane are placed;

FIG. 2 is a sectional view showing that the upper and lower halves of the vane are mated with each other in the mold; and

FIG. 3 is a sectional view of the vane of the ceiling fan, which is manufactured by the method of the present invention.

### DETAILED DESCRIPTION OF THE PREFERRED EMBODIMENT

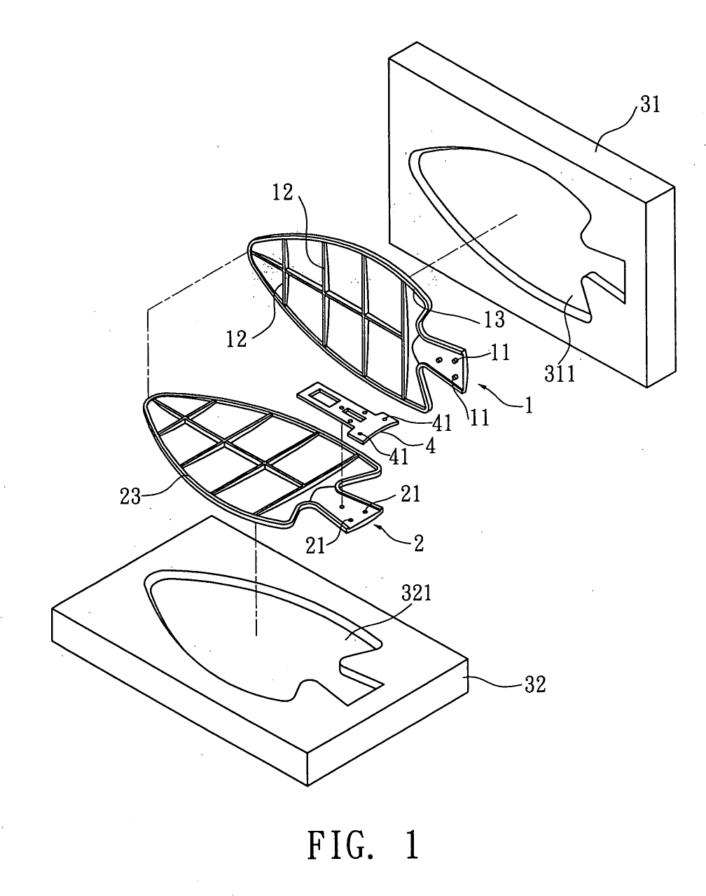

Please refer to FIGS. 1 to 3. The method for manufacturing a vane of ceiling fan of the present invention includes steps of:

making an upper half 1 and a lower half 2 of the vane by means of injection molding, the upper half 1 and lower half 2 of the vane having symmetrical profiles, each of the upper half 1 and lower half 2 of the vane having a recessed mating face 13, 23 on which multiple reinforcing ribs 12 are formed for reinforcing the upper half 1 and lower half 2 of the vane, each of the upper half 1 and lower half 2 of the vane having a rear end, the rear ends of the upper half 1 and lower half 2 of the vane being respectively formed with several tenons 11 and corresponding mortises 21;

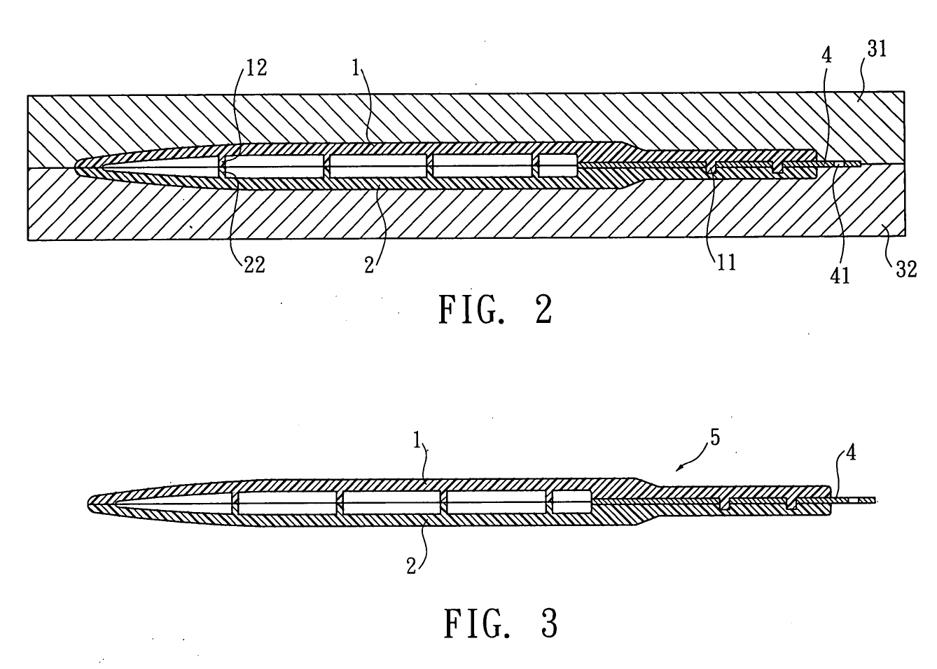

mating the upper half 1 and lower half 2 of the vane, the upper half 1 and lower half 2 of the vane being respectively placed into the mold cavities 311, 321 of an upper mold section 31 and a lower mold section 32 of a vibrational friction device (not shown), a vane bracket 4 having locating holes 41 being placed between the upper half 1 and lower half 2 of the vane, the mating faces 13, 23 of the upper half 1 and lower half 2 of the vane being mated with each other with the tenons 11 passing through the locating holes 41 of the vane bracket 4 and fitting into the mortises 21 as shown in FIG. 2; and

activating the vibrational friction device which is high-frequency vibrated several thousand times per second by means of an electromagnetic measure or a mechanical measure, the vibrational friction device being such vibrated that the mating faces 13, 23 of the upper and lower halves 1, 2 melt due to thermal friction effect, whereby the upper and lower halves 1, 2 of the vane and the vane bracket 4 are tightly combined as shown in FIG. 3.

According to the above arrangement, the present invention has the following advantages:

1. The vane has a lighter weight. The vane has a simplified structure and lighter weight.

2. It is easy to manufacture the vane. The upper and lower halves of the vane are placed into the mold cavities of the upper and lower molds and associated into the vane by means of vibrational friction.

3. The vane has better strength. By means of the vibrational friction, the upper and lower halves of the vane are associated with each other with better bonding effect. Therefore, during high-speed rotation, the vane will not break apart so as to ensure safety.

4. The cost is lower. The vane bracket and the vane are tightly associated with each other without using any screw. Therefore, the vane bracket and the vane can be more easily assembled and thus the manufacturing cost is greatly lowered.

The above embodiment is only used to illustrate the present invention, not intended to limit the scope thereof. Many modifications of the above embodiment can be made without departing from the spirit of the present invention.

What is claimed is:

1. A method for manufacturing a vane of ceiling fan, comprising steps of:
making an upper half and a lower half of the vane by means of injection molding, the upper half and lower half of the vane having symmetrical profiles and respectively having two recessed mating faces for mating with each other;
mating the upper half and lower half of the vane, the upper half and lower half of the vane being respectively placed into the mold cavities of an upper mold section and a lower mold section of a vibrational friction device, whereby the mating faces of the upper half and lower half of the vane are mated with each other; and
activating the vibrational friction device to vibrate at high-frequency, whereby the mating faces of the upper and lower halves of the vane melt due to thermal friction effect and integrally associate with each other to form a hollow vane.

2. The method as claimed in claim 1, wherein each of the upper half and lower half of the vane has a rear end, the rear ends of the upper half and lower half of the vane are respectively formed with several tenons and corresponding mortises, a vane bracket having locating holes being placed between the upper half and lower half of the vane, the mating faces of the upper half and lower half of the vane being mated with each other with the tenons passing through the locating holes of the vane bracket and fitting into the mortises.
